(19) United States
(12) Patent Application Publication
(10) Pub. No.: US 2014/0253536 A1
(43) Pub. Date: Sep. 11, 2014

(54) DRIVER IC AND DISPLAY-INPUT DEVICE

(71) Applicant: Renesas SP Drivers Inc., Tokyo (JP)

(72) Inventors: Hideaki Honda, Kodaira (JP); Hirofumi Sonoyama, Kodaira (JP); Kazuhiro Okamura, Kodaira (JP)

(73) Assignee: Renesas SP Drivers Inc., Tokyo (JP)

(21) Appl. No.: 14/194,702

(22) Filed: Mar. 1, 2014

(30) Foreign Application Priority Data
Mar. 5, 2013 (JP) 2013-042750

(51) Int. Cl. G09G 3/36

(52) U.S. Cl. CPC G09G 3/3696
USPC 345/213; 345/87

(57) ABSTRACT

The driver IC generates a common voltage to be applied to a common electrode of pixels of a display panel, and generates a high level of a pulse voltage used for driving, by pulses, drive electrodes of a touch panel with its low level set at the common voltage based on data held by a memory region for holding voltage-designating data of the common voltage and amplitude-designating data of the pulse voltage. In addition, the driver IC outputs the common voltage to drive terminals in synchronization with the action timing of the display panel, and outputs a pulse voltage having an amplitude of the high level with respect to the common voltage to the drive terminals in synchronization with the action timing of a touch panel.

### CROSS-REFERENCE TO RELATED APPLICATIONS

The Present application claims priority from Japanese application JP 2013-042750 filed on Mar. 5, 2013, the content of which is hereby incorporated by reference into this application.

### BACKGROUND

The present invention relates to a driver IC for activating a display panel and a touch panel, and a display-input device having a panel module equipped with such a driver IC, and it relates to a technique useful in application to a portable information terminal device, e.g. a smart phone.

Touch panels have been widely used for user interfaces for portable information terminal devices including tablet terminal devices and smart phones. In recent years, a display panel, e.g. an in-cell type display panel having a liquid crystal display panel and a touch panel which are integrated into a single unit, is becoming widespread as a touch panel which can be made slimmer. An example of an in-cell type liquid crystal display panel has been described in e.g. JP-A-2012-230657.

According to the in-cell technique, a liquid crystal display panel is arranged so that the common electrode (VCOM electrode) of pixels can double as a drive electrode (Tx electrode) of a touch panel. In a display-drive period in one display frame, an action for display is performed by applying a common voltage to the shared electrode, whereas in a non-display-drive period, a touch-detection action is performed by applying a drive pulse to the shared electrode. In touch detection, a change of a drive pulse owing to the application of the drive pulse to the shared electrode causes a potential change on a detection electrode through a touch detection capacitance, and a touch detection signal can be obtained by integrating the potential change. With a stray capacitance formed by a finger in the vicinity of a touch detection capacitance, the combined capacitance thereof drops owing to it, thereby changing a detection signal. Based on the presence or absence of such signal change, the judgment on whether the touch panel is “being touched or not” can be performed. Therefore, to achieve a desired accuracy in touch detection, it is necessary to keep the amplitude of a drive pulse constant. In this regard, in the example of an in-cell type liquid crystal display panel of JP-A-2012-230657, the common voltage (VcomDC) is set to 0 volt, and a drive pulse is produced by use of the common voltage 0 volt and a fixed High level (VcomH).

### SUMMARY

The inventor has made a study about keeping the amplitude of a drive pulse used in touch detection fixed. According to the study, the optimum value of the common voltage changes in such display panels because of the variation in the manufacturing of a liquid crystal display panel and the like, which does not take a fixed voltage such as 0 volt, but varies. Further, the optimum value of the common voltage varies depending on the display mode for driving display lines in an ascending order, a descending order or the like. Hence, the inventor found that under the circumstances, it is not easy to keep the amplitude of a drive pulse for touch detection in the case of producing the drive pulse by use of the common voltage (VcomDC) accompanied by variation and a fixed high level (VcomH). Now, it is noted that in the course of the study, the consideration was made on a method by which a common voltage (VcomDC) is used to drive a shared electrode in a display-drive period, and a fixed voltage such as zero volt is used instead of the common voltage (VcomDC) to produce a drive pulse between the fixed voltage and a predetermined high level (VcomH) in a touch-detection period. According to the method like this, the amplitude of the drive pulse can be kept constant even with the common voltage (VcomDC) accompanied by variation. However, it was found that the method has a problem as described below. The shared electrode definitely requires charging and discharging between zero volt and the common voltage (VcomDC) when switching an action between display and touch detection, which increases the power consumption, undesirably shortens a spare time usable for display and touch detection in a display frame period, and additionally increases the number of kinds of output voltages of a drive circuit having a large chip footprint to three, resulting in the increase in the circuit scale.

Therefore, it is an object of the invention to provide a driver IC which facilitates ensuring the detection accuracy required for touch detection by use of a drive pulse depending on the common voltage even with the common voltage's optimum value accompanied by variation. Further, it is an object of the invention to provide a display-input device having a panel module with such driver IC.

The above and other problems of the invention, and novel features thereof will become apparent from the description hereof and the accompanying drawings.

Of the embodiments herein disclosed, the representative embodiment will be briefly outlined below.

The driver IC according to the embodiment generates a common voltage to be applied to a common electrode of pixels of a display panel, and generates a high level of a pulse voltage used for driving, by pulses, drive electrodes of a touch panel with its low level set at the common voltage based on data held by a memory region for holding voltage-designating data of the common voltage and amplitude-designating data of the pulse voltage. Further, the driver IC outputs the common voltage to drive terminals in synchronization with the action timing of the the display panel, and outputs a pulse voltage having an amplitude of the high level with respect to the common voltage to the drive terminals in synchronization with the action timing of the touch panel.

Of the embodiment herein disclosed, the representative embodiment brings about the effect as briefly described below.

Even with the common voltage's optimum value accompanied by variation coming from a liquid crystal display panel per se, such variation is reflected by voltage-designating data and in addition, the amplitude of a drive pulse optimum for touch detection is reflected by amplitude-designating data. Thus, the detection accuracy required for touch detection by use of a drive pulse arranged with reference to the common voltage can be ensured even with the common voltage's optimum value accompanied by variation.

### BRIEF DESCRIPTION OF THE DRAWINGS

FIG. 1 is a block diagram showing, by example, the structure of a driver IC;

FIG. 2 is an explanatory diagram schematically showing, by example, the arrangement of electrodes of a panel module which constitutes, in combination with the driver IC, a display device;

FIG. 3 is an explanatory diagram showing, by example, an action of generating a voltage by use of voltage-designating data Dvcom and amplitude-designating data Dampt;

FIG. 4 is an explanatory diagram showing, as a comparative example, voltage generation in the case of designating the high level voltage of a drive pulse instead of amplitude-designating data Dampt;

FIG. 5 is a block diagram showing systems for generating a drive pulse PLStx and a common voltage VcomDC in a simplified form in addition to a specific example of a memory region; and

FIG. 6 is a block diagram showing systems for generating the drive pulse PLStx and the common voltage VcomDC in a simplified form in addition to a specific example of the voltage-generation circuit mainly composed of an analog circuit.

### DETAILED DESCRIPTION

### 1. Summary of the Embodiments

The embodiments herein disclosed will be outlined first. Here, the reference numerals for reference to the drawings, which are accompanied with paired round brackets, only exemplify what the concepts of parts or components referred to by the numerals contain.

[1] <Driver IC which Generates a Scan-Drive Voltage by Scan-Drive-Amplitude-Designating Data with Reference to a Common Electrode Voltage>

The driver IC (4) operable to operate a display panel (2) and a touch panel (3), includes: a memory region (60) for holding voltage-designating data (Dvcom) of a common voltage (VcomDC) to be applied to a common electrode (VCOM) of pixels of the display panel, and amplitude-designating data (Dampt) of a pulse voltage (PLStx) used for driving, by pulses, drive electrodes (TA1 to TXm) of the touch panel; a voltage-generation circuit (42, 42a) operable to generate the common voltage based on the voltage-designating data and the amplitude-designating data held by the memory region, and to generate a high level of the pulse voltage with its low level set at the common voltage; and a drive circuit (31) operable to output a common voltage generated by the voltage-generation circuit in synchronization with an action timing of the display panel, and to output a pulse voltage having an amplitude of the high level with respect to the common voltage generated by the voltage-generation circuit in synchronization with an action timing of the touch panel.

According to the arrangement like this, even with the common voltage's optimum value accompanied by variation coming from a liquid crystal display panel per se, such variation is reflected by voltage-designating data and in addition, the amplitude of a drive pulse optimum for touch detection is reflected by amplitude-designating data. Thus, the detection accuracy required for touch detection by use of a drive pulse arranged with reference to the common voltage can be ensured even with the common voltage's optimum value accompanied by variation. The need for adopting, as a DC reference level of the drive pulse, a fixed voltage such as the ground level is eliminated and as such, the number of kinds of output voltages of the drive circuit is not increased; the power consumption is not increased; the spare time which can be used for display and touch detection in one display frame period is never shortened; and the circuit scale of the drive circuit is not increased.

[2] <Control of Display Driving and Non-Display Driving in a Division Manner>

The driver IC as described in [1] further includes: a liquid crystal display-control circuit (22) operable to control the action timings of the display panel and the touch panel with one frame period of the display panel divided to include a display-drive period and a non-display-drive period. The liquid crystal display-control circuit causes the drive circuit to output a common voltage in the display-drive period, and the drive circuit to output a pulse voltage in the non-display-drive period.

According to the arrangement like this, the drive circuit can be readily controlled in output action according to the display-drive period and the non-display-drive period.

[3] <First and Second Memory Regions Formed by Non-Volatile Registers>

In the driver IC as described in [2], the memory region is formed by first non-volatile registers (60A, 60B) for storing the voltage-designating data and a second non-volatile register (60C) for storing the amplitude-designating data.

According to the arrangement like this, the optimum value of the common voltage depending on the display panel and the touch panel can be determined in the stage of a module test on a panel module with the driver IC. In most cases, once the optimum value is determined, it is not required to change the optimum value. Further, it is expected that the drive pulse amplitude requires appropriately changing keeping a good balance with the detection sensitivity of the touch panel and its low-power consumption mode in terms of the system operation. Taking account of the difference, it is convenient from the viewpoint of use to arrange the memory region for storing the two kinds of data so as to be composed of different non-volatile registers.

[4] <Host Interface>

In the driver IC as described in [3], the second non-volatile register includes a register which is electrically writable from outside through a host interface (40).

The arrangement like this can serve for overwrite of the amplitude-designating data. For such electrically writable register, a storage element for a flash memory of e.g. a MONOS (Metal Oxide Nitride Oxide Semiconductor) structure may be adopted. The first non-volatile registers which are not designed on the premise that they are subjected to overwrite may be each composed of a trimming circuit with an electric fuse incorporated therein as long as all that is required is just one write thereon.

[5] <More than One Kind of Voltage-Designating Data>

In the driver IC as described in [4], the first non-volatile registers have memory regions (60A, 60B) for separately storing more than one piece of the voltage-designating data. The liquid crystal display-control circuit selects a required piece of voltage-designating data out of the first non-volatile registers according to a display mode, and provides the voltage-generation circuit therewith.

According to the arrangement like this, in a case where even the display mode for driving display lines in an ascending order, a descending order or the like makes a difference in the optimum value of the common voltage, the optimum common voltage can be adopted according to the display mode, and the switching of the common voltage has no influence on the pulse amplitude of the drive pulse.

[6] <Generation of the Scan-Drive Voltage Through a Digital Arithmetic Calculation Process of Amplitude-Designating Data, Etc.>

In the driver IC as described in [1], the voltage-generation circuit includes: a digital calculation circuit (52) operable to accept inputs of the amplitude-designating data and the voltage-designating data, and to add a value of the amplitude-designating data to a value of the voltage-designating data; a high-level generation circuit (51) operable to convert addition data resulting from the addition by the digital calculation circuit into an analog voltage to generate the high level; and a common voltage-generation circuit (50) operable to convert the voltage-designating data into an analog voltage to generate the common voltage.

According to the arrangement like this, the actions except the conversion action of converting a digital signal into an analog signal can be realized by digital data processing. This is preferable for decreasing the number of analog circuit parts mounted on the chip of a driver IC in combination.

[7] <Generation of the Scan-Drive Voltage Through an Adding Process of an Analog-Converted Voltage of Amplitude-Designating Data or the Like>

In the driver IC as described in [1], the voltage-generation circuit has: an amplitude voltage-generation circuit (53) operable to convert the amplitude-designating data into an analog voltage to generate an amplitude voltage; a common voltage-generation circuit (50) operable to convert the voltage-designating data into an analog voltage to generate the common voltage; and an analog adding circuit (54) operable to add, in analog, the amplitude voltage generated by the amplitude voltage-generation circuit to the common voltage generated by the common voltage-generation circuit to generate the high level.

According to the arrangement like this, a digital signal is converted into an analog signal and as such, a required voltage adding calculation or the like can be realized by analog processing. This is preferable for increasing the number of analog circuit parts mounted on the chip of a driver IC in combination.

[8] <Driver IC which Generates a Scan-Drive Voltage by Scan-Drive-Amplitude-Designating Data with Reference to a Common Electrode Voltage>

The driver IC (4) operable to activate a display panel (2) and a touch panel (3), includes: a first drive circuit (21) operable to drive signal electrodes of pixels of the display panel by use of first drive terminals (Psc); a second drive circuit (31) operable to drive a shared electrode (TX1 to TXm) doubling as a common electrode (VCOM) of pixels of the display panel and part of drive electrodes (TX1 to TXm) of the touch panel by use of corresponding one of second drive terminals (Ptx); a detection circuit (30) operable to detect a voltage change taken from a detection electrode of the touch panel; a liquid crystal display-control circuit (22) operable to control action timings of the first drive circuit, the second drive circuit, and the detection circuit with one frame period of the display panel divided to include a display-drive period and a non-display-drive period; a memory region (60) for holding voltage-designating data (Dvcom) of a common voltage used for driving the shared electrode, and amplitude-designating data (Dampt) of a pulse voltage used for driving the shared electrode; and a voltage-generation circuit (42, 42a) operable to generate the common voltage based on the voltage-designating data and the amplitude-designating data held by the memory region, and to generate a high level of the pulse voltage with its low level set at the common voltage. The liquid crystal display-control circuit causes the first drive circuit to drive the signal electrodes, and the second drive circuit to drive the second drive terminals by use of the common voltage generated by the voltage-generation circuit in the display-drive period. Further, the liquid crystal display-control circuit stops the first drive circuit from driving the signal electrodes, and causes the detection circuit to perform a detecting action, and the second drive circuit to drive the second drive terminals with a pulse voltage having an amplitude of the high level with respect to the common voltage generated by the voltage-generation circuit in the non-display-drive period.

According to the arrangement like this, even with the common voltage's optimum value accompanied by variation coming from a liquid crystal display panel per se, such variation is reflected by voltage-designating data and in addition, the amplitude of a drive pulse optimum for touch detection is reflected by amplitude-designating data. Thus, the detection accuracy required for touch detection by use of a drive pulse arranged with reference to the common voltage can be ensured even with the common voltage's optimum value accompanied by variation. The need for adopting, as a DC reference level of the drive pulse, a fixed voltage such as the ground level is eliminated and as such, the number of kinds of output voltages of the drive circuit is not increased; the power consumption is not increased; the spare time which can be used for display and touch detection in one display frame period is never shortened; and the circuit scale of the drive circuit is not increased.

[9] <Display-Input Device>

The display-input device includes: a panel module (1) including a display panel (2) and a touch panel (3) incorporated in the display panel; and a driver IC (4) operable to activate the display panel and the touch panel and mounted on the panel module. Part of drive electrodes (TX1 to TXm) of the touch panel doubles as a common electrode (VCOM) of pixels of the display panel. Detection electrodes (RX1 to RXn) of the touch panel with touch detection capacitances (Ctp) formed at their intersections with the drive electrodes, and scan electrodes (GL1 to GLmk) and signal electrodes (SL1 to SLj) of the pixels of the display panel connected with the common electrode are individuated respectively. The driver IC has: a first drive circuit (21) operable to drive signal electrodes of pixels of the display panel; a second drive circuit (31) operable to drive a shared electrode doubling as the common electrode and the drive electrode; a detection circuit (30) operable to detect a voltage change taken from a detection electrode of the touch panel; a memory region (60) for holding voltage-designating data of a common voltage used for driving the shared electrode and amplitude-designating data of a pulse voltage used for driving the shared electrode; and a voltage-generation circuit (42, 42a) operable to generate the common voltage based on the voltage-designating data and the amplitude-designating data held by the memory region, and to generate a high level of the pulse voltage with its low level set at the common voltage. The second drive circuit drives the shared electrode by use of the common voltage generated by the voltage-generation circuit according to the driving of the signal electrodes by the first drive circuit. Further, the second drive circuit drives the shared electrode with a pulse voltage having an amplitude of the high level with respect to the common voltage generated by the voltage-generation circuit, according to the stop of signal electrode driving by the first drive circuit and a detecting action by the detection circuit.

According to the arrangement like this, even with the common voltage's optimum value accompanied by variation coming from a liquid crystal display panel per se, such variation is reflected by voltage-designating data and in addition, the amplitude of a drive pulse optimum for touch detection is reflected by amplitude-designating data. Thus, the detection accuracy required for touch detection by use of a drive pulse arranged with reference to the common voltage can be ensured even with the common voltage's optimum value accompanied by variation. The need for adopting, as a DC reference level of the drive pulse, a fixed voltage such as the ground level is eliminated and as such, the number of kinds of output voltages of the drive circuit is not increased; the power consumption is not increased; the spare time which can be used for display and touch detection in one display frame period is never shortened; and the circuit scale of the drive circuit is not increased. Therefore, a high touch detection accuracy can be realized readily in an in-cell type panel module.

### 2. Further Detailed Description of the Embodiments

The embodiments will be described further in detail.

<<Display-Input Device>>

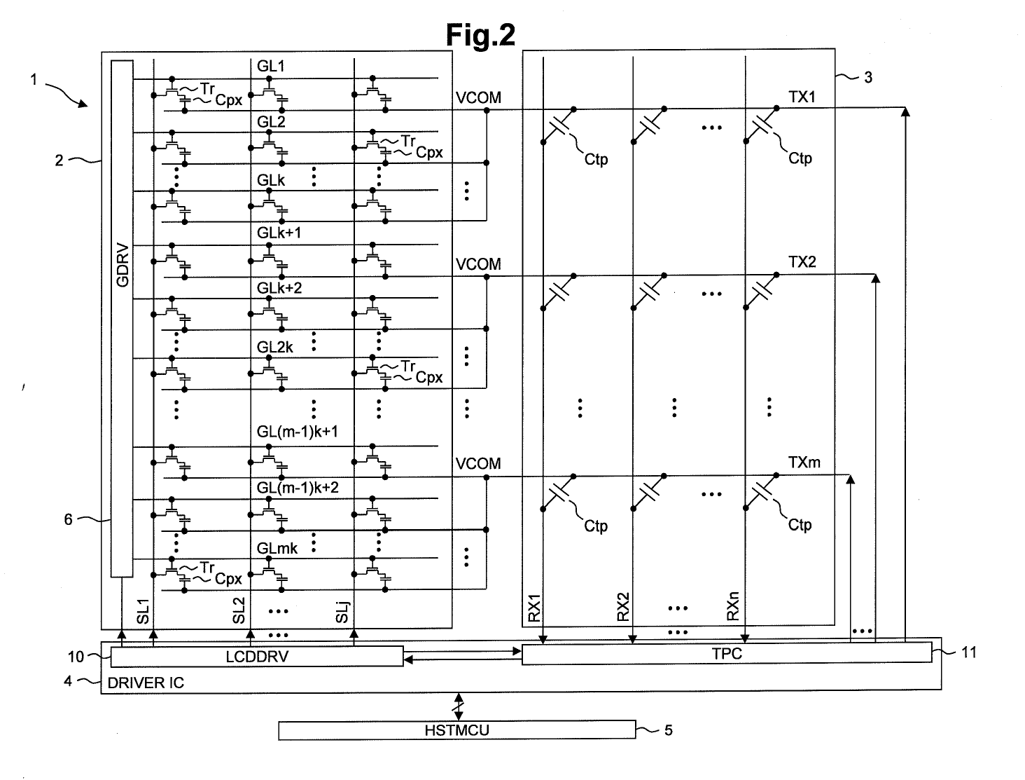

FIG. 2 shows, by example, a display-input device having a panel module 1 and a driver IC 4 operable to activate the panel module. The panel module 1 is arranged in a so-called in-cell form in which a touch panel 3 is incorporated in a liquid crystal display panel 2—an example of the display panel. The panel module has, on e.g. a glass board, a TFT array substrate with combinations of TFTs and pixel electrodes arranged like a matrix, and further a liquid crystal layer, a common electrode layer opposed to the pixel electrodes, a color filter, touch detection electrodes, a surface glass, and the like, which are stacked on the TFT array substrate. Although in FIG. 2, the liquid crystal display panel 2 and the touch panel 3 are illustrated on the left and right sides respectively for the sake of convenience, actually they are laid one on top of the other.

According to the embodiment shown in FIG. 2, the liquid crystal display panel 2 has e.g. a thin-film transistor Tr termed “TFT” which is disposed at each intersection point of scan electrodes GL1 to GLmk (m and k are each a positive integer) and signal electrodes SL1 to SLj (j is a positive integer) arranged to intersect one another. The scan electrodes GL1 to GLmk are provided corresponding to gates of the thin-film transistors Tr, the signal electrodes SL1 to SLj are provided corresponding to sources of the thin-film transistors Tr, and a combination of one liquid crystal element and one storage capacitor (which is represented by one capacitor Cpx in the drawing) making a sub-pixel is connected between the drain of each thin-film transistor Tr and the common electrode VCOM, whereby pixels of the display panel are formed. Now, a line of pixels arrayed along each of the scan electrodes GL1 to GLmk is referred to as “display line”. In display control, the scan electrodes GL1 to GLmk are driven sequentially. Then, the thin-film transistors Tr are turned ON in units of scan electrodes. In each thin-film transistor put in ON state, current is caused to flow between its source and drain, when signal voltages put on the sources through the signal electrodes SL1 to SLj are applied to the liquid crystal elements Cpx, whereby the state of the liquid crystal is controlled.

The touch panel 3 is of an electrostatic capacitance type, which has e.g. lots of touch detection capacitances Ctp formed like a matrix at intersection points of drive electrodes TX1 to TXm and detection electrodes RX1 to RXn arranged to intersect one another. Although no special restriction is intended, in the display-input device shown in FIG. 2, the common electrode is divided in m for each of k display lines, and the resultant electrodes are arranged to double as the corresponding drive electrodes TX1 to TXm, for slimming the panel module 1. The drive electrodes TX1 to TXm are shared electrodes arranged to double as the common electrodes VCOM. Now, it is noted that the drive electrodes TX1 to TXm and the corresponding common electrode VCOM are also referred to as “shared electrodes TX1 to TXm” for the sake of convenience. On condition that the drive electrodes TX1 to TXm are driven sequentially and thus, potential changes arise on the detection electrodes RX1 to RXn through the touch detection capacitances Ctp, detection signals can be formed by integrating the potential changes for each of the detection electrodes RX1 to RXn. In case that a finger is brought close to the detection capacitances, the stray capacitance of the finger is combined with the detection capacitances Ctp, and thus the combined capacitance values become smaller. The touch panel is arranged to discriminate between the states of “being touched” and “being untouched” based on the differences of the detection signals according to the changes of the capacitance values. Because of using the touch panel 3 superposed on the liquid crystal display panel 2, the operation can be determined from touch coordinates of the place where a touch operation is conducted on the touch panel 3 according to display on a screen of the liquid crystal display panel 2.

The driver IC 4 serves as a controller device or a driver device operable to perform the display driving on the liquid crystal display panel 2 and the touch driving and detection on the touch panel 3. The driver IC 4 is mounted on the TFT substrate of the panel module in a form such as COG (Chip on Glass). For instance, the driver IC 4 is connected with a host processor (HSTMCU) 5 of an information terminal device such as a smart phone which has the panel module 1 as a user interface. The input and output of an action command, display data, touch detection coordinate data, etc. are performed between the the driver IC 4 and the host processor 5.

Although no special restriction is intended, the driver IC 4 is arranged in the form of a semiconductor integrated circuit equipped with a liquid crystal display driver (LCDDRV) 10 and a touch panel controller (TPC) 11. The driver IC 4 arranged in the form of a semiconductor integrated circuit is formed on a substrate of a semiconductor such as monocrystalline silicon by e.g. the CMOS IC manufacturing technique. Although no special restriction is intended, in the example of FIG. 2, the circuit serving to drive the scan electrodes GL1 to GLmk is provided in the liquid crystal display panel 2 as a gate driver IC (GDRV) 6. The driver IC 4 drives the signal electrodes SL1 to SLj in synchronization with a frame synchronizing signal such as a vertical synchronizing signal, and supplies the gate driver IC 6 with the timing of driving the scan electrodes GL1 to GLmk and the like. The gate driver IC 6 drives the scan electrodes GL1 to GLmk according to the timing supplied from the driver IC 4.

Although no special restriction is intended, the liquid crystal display driver 10 controls the liquid crystal display panel 2 differently depending on whether it is in a display-drive period or a non-display-drive period subsequent to the display-drive period in one display frame period. The number of display-drive period divisions and the number of the non-display-drive period divisions may be an appropriate number such as two. For instance, the liquid crystal display driver divides the scan electrodes GL1 to GLmk into m/i blocks in groups of k×i (i is a positive integer) electrodes with the display-drive period divided into m/i display-drive period divisions, drives k×i scan electrodes of the corresponding block sequentially in each display-drive period division, and drives the signal electrodes SL1 to SLj by display data of the corresponding display line in line with the timing of driving the scan electrodes. The liquid crystal display driver 10 provides the gate driver IC 6 with the drive timing for the scan electrodes of the block corresponding to a display-drive period division. Also, the liquid crystal display driver 10 stops driving the signal electrodes SL1 to SLj in a non-display-drive period division, and then notifies the touch panel controller 11 that it is able to work for touch detection. In each non-display-drive period division, the touch panel controller 11 sequentially drives, of the drive electrodes TX1 to TXm, a predetermined range by pulses, and integrates potential changes arising on the detection electrodes RX1 to RXn through the touch detection capacitances Ctp, thereby forming detection signals. Then, the touch panel controller supplies the detection signals thus obtained to the host processor 5. The host processor 5 calculates touch coordinates based on the detection signals, and interprets the meaning of the touch operation on the display image. While not shown in the drawing, a subprocessor which receives detection signals obtained by the touch panel controller 11 and calculates touch coordinates may be mounted on the chip of the driver IC.

<<Driver IC>>

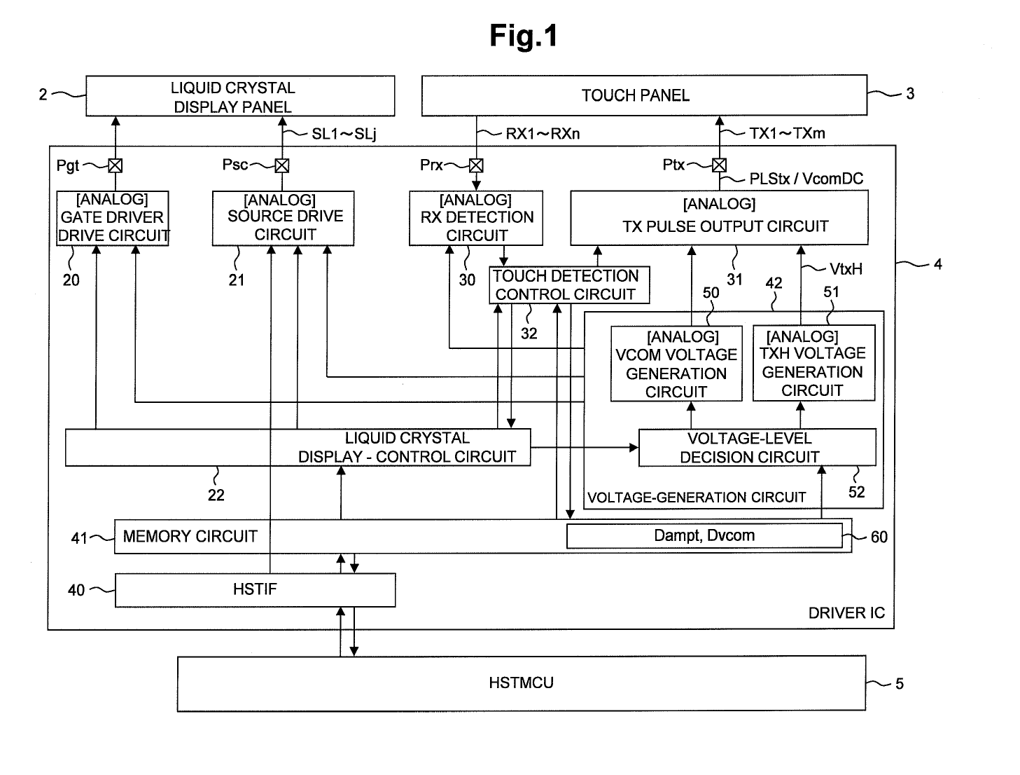

FIG. 1 shows, by example, the structure of the driver IC 4. In FIG. 1, the liquid crystal display driver 10 and the touch panel controller 11 are illustrated like a coherent whole in combination. The gate driver drive circuit 20 operable to output a gate-drive-timing signal of the gate driver IC 6 and the like, the source-drive circuit 21 for driving the signal electrodes SL1 to SLj, and the liquid crystal display-control circuit 22 chiefly form components of the liquid crystal display driver 10. The TX pulse output circuit 31 operable to drive the shared electrodes TX1 to TXm which double as the drive electrodes TX1 to TXm and the common electrode VCOM, the RX detection circuit 30 operable to integrate potential changes arising on the detection electrodes RX1 to RXn thereby forming detection signals, and the touch detection control circuit 32 chiefly make components of the touch panel controller 11. The host processor 5, the host interface (HSTIF) 40 operable to accept input and output of commands, data, etc., the memory circuit 41, and the voltage-generation block 42 are components which involve in both the function of the liquid crystal display driver 10 and the function of the touch panel controller 11.

The memory circuit 41 includes: a command register, a data register and a non-volatile register and the like. The liquid crystal display-control circuit 22 accepts the input of a vertical synchronizing signal VSYNC used as a frame synchronizing signal, which defines one frame period for example. One frame represents a cycle of e.g. 60 Hz. The period of one frame includes, in addition to back and front porches, the display-drive periods and non-display-drive periods as described above. The host processor 5 defines each period on the register circuit of the memory circuit 41 using e.g. the line cycle of display lines as a unit.

The liquid crystal display-control circuit 22 has a display line counter or the like. The liquid crystal display-control circuit compares a count value thereof with set values of the display-drive period and the non-display-drive period; in a display-drive period, it supplies the source-drive circuit 21 with display data of the display line depending on the count value to drive the signal electrodes SL1 to SLj and in parallel, provides the gate driver drive circuit 20 with a gate-drive-timing signal of the gate driver IC 6 to drive the scan electrodes (GL1 to GLmk) associated with the display line of the present turn. Further, in line with a display-drive period, the liquid crystal display-control circuit 22 controls, through the touch detection control circuit 32, the TX pulse output circuit 31 to output a common voltage VcomDC from the shared electrodes TX1 to TXm, thereby driving the potential of the common electrode VCOM of the liquid crystal display panel 2 to a common voltage VcomDC.

On the other hand, in a non-display-drive period, the liquid crystal display-control circuit 22 causes the source-drive circuit 21 to stop driving the signal electrodes SL1 to SLj (which are left keeping an output just before the stopping, put in a high-output impedance state, or kept outputting a fixed gradation voltage), and uses the gate driver drive circuit 20 to put the scan electrodes GL1 to GLmk in a unselect state (thereby, putting the thin-film transistors Tr in the cutoff state). In this condition, the liquid crystal display-control circuit 22 starts the touch detection control circuit 32 detecting a touch in line with a non-display-drive period. In touch detection, the liquid crystal display-control circuit 22 refers to the count value of the display line counter, controls the TX pulse output circuit 31 to output a drive pulse PLStx to the shared electrode (TX1 to TXm) of a line with a touch detected thereon at present, hereinafter referred to as “touch detection line”, and controls the RX detection circuit 30 to form detection signals by integrating potential changes arising on the detection electrodes RX1 to RXn in synchronization with the drive pulse PLStx. The detection signals are accumulated in the memory circuit 41, and provided to the host computer 5 in units of signals associated with a predetermined touch detection line for the coordinate calculation.

Now, the character string “Ptx” generically denotes output terminals of the drive pulse PLStx or common voltage VcomDC corresponding to the shared electrodes TX1 to TXm. The character string “Prx” generically denotes input terminals of detection signals arising on the detection electrodes RX1 to RXn. The character string “Psc” generically denotes output terminals (drive terminals) corresponding to the signal electrodes SL1 to SLj. The character string “Pgt” generically denotes gate-drive-timing signal output terminals of the gate driver IC 6.

The voltage-generation circuit 42 produces, according to a set value in the memory circuit 41, and an instruction from the liquid crystal display-control circuit 22, a high level voltage VtxH of the drive pulse PLStx, a common voltage VcomDC, a precahrge voltage to a detection node of the RX detection circuit 30, gradation voltages for driving the signal electrodes SL1 to SLj, a gate-drive-timing signal voltage and the like, and outputs them to the appropriate parts. The structure for generating the high level voltage VtxH of the drive pulse PLStx, and the common voltage VcomDC will be described in detail below.

<<Generation of the High Level Voltage VtxH and the Common Voltage VcomDC>>

FIG. 1 shows, by example, the structure of the voltage-generation circuit 42 for generating the high level voltage VtxH and the common voltage VcomDC. Specifically, a VCOM voltage-generation circuit 50, a TXH voltage-generation circuit 51 and a voltage-level decision circuit 52 serving as a digital calculation circuit, which are arranged for generating the high level voltage VtxH of the drive pulse PLStx and the common voltage VcomDC, are exemplified. The memory circuit 41 has a memory region 60 for holding voltage-designating data Dvcom for setting the common voltage VcomDC, and amplitude-designating data Dampt for setting the amplitude of the pulse voltage PLStx. The voltage-designating data Dvcom is e.g. digital data showing a voltage value with reference to the ground level. The amplitude-designating data Dampt is digital data designating a potential difference. The resolutions of the two kinds of data may be identical to each other, otherwise may be different from each other as long as the voltage-level decision circuit 52 has a decode circuit provided therein.

According to an instruction from the liquid crystal display-control circuit 22, the voltage-level decision circuit 52 adds amplitude-designating data Dampt to voltage-designating data Dvcom in the memory region 60. Then, TXH voltage-generation circuit 51 converts the result of the addition to an analog voltage to generate a high level voltage VtxH of the drive pulse PLStx, and the VCOM voltage-generation circuit 50 converts the voltage-designating data Dvcom to an analog voltage to generate the common voltage VcomDC. The TX pulse generation circuit 31 outputs the common voltage VcomDC to the shared electrodes TX1 to TXm in a display-drive period. In a non-display-drive period, the TX pulse generation circuit 31 outputs a drive pulse PLStx having the common voltage VcomDC as its low level and the voltage VtxH as its high level to touch detection line shared electrodes of the shared electrodes TX1 to TXm, sequentially.

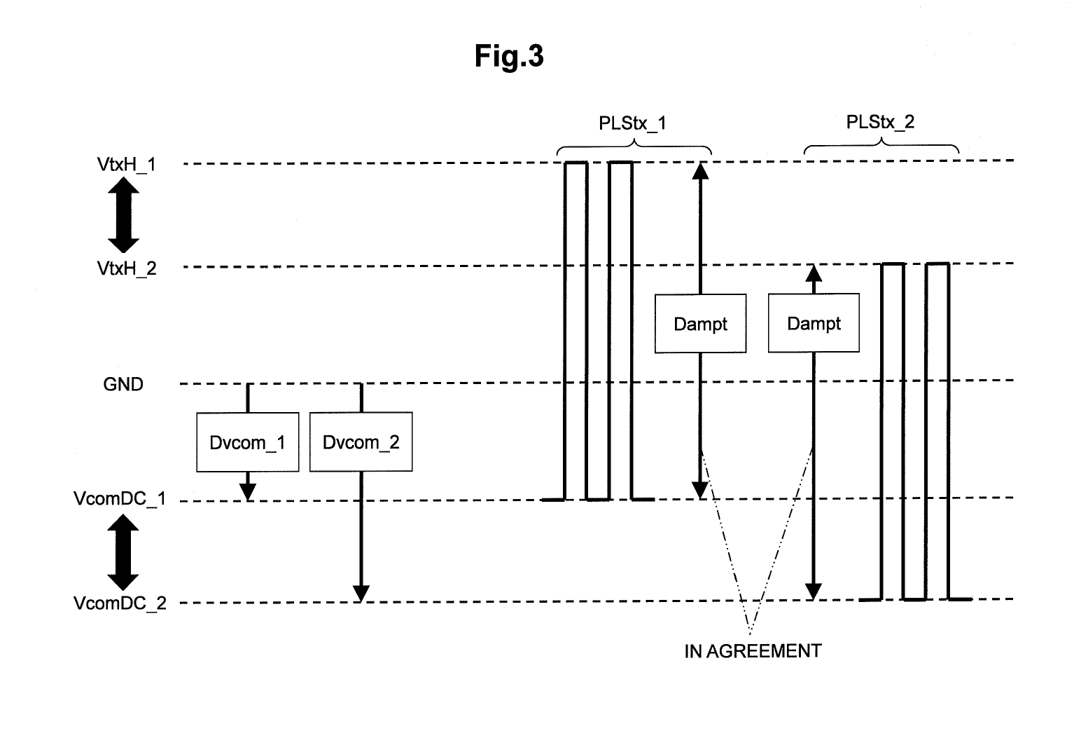

Referring to FIG. 3, an example in which a voltage is generated by use of voltage-designating data Dvcom and amplitude-designating data Dampt will be described. For instance, in the case of using voltage-designating data Dvcom_1 and amplitude-designating data Dampt, a voltage VcomDC_1 is generated as the common voltage, and a voltage VtxH_1 is generated as the high level voltage of the drive pulse PLStx_1; the drive pulse PLStx_1 varies with an amplitude having the voltage VcomDC_1 as the low level and the voltage VtxH_1 as the high level. In contrast, in the case of using different voltage-designating data Dvcom_2 as an optimum common voltage, a VcomDC_2 is generated as the common voltage, and a voltage VtxH_2 is generated as the high level voltage of the drive pulse PLStx_2; the drive pulse PLStx_2 varies with an amplitude having the voltage VcomDC_2 as the low level and the voltage VtxH_2 as the high level. Even if the optimum common voltage is changed, the drive pulse PLStx_1 is identical to the drive pulse PLStx_2 in amplitude and therefore, the same the touch detection accuracy can be achieved in the two cases as described above.

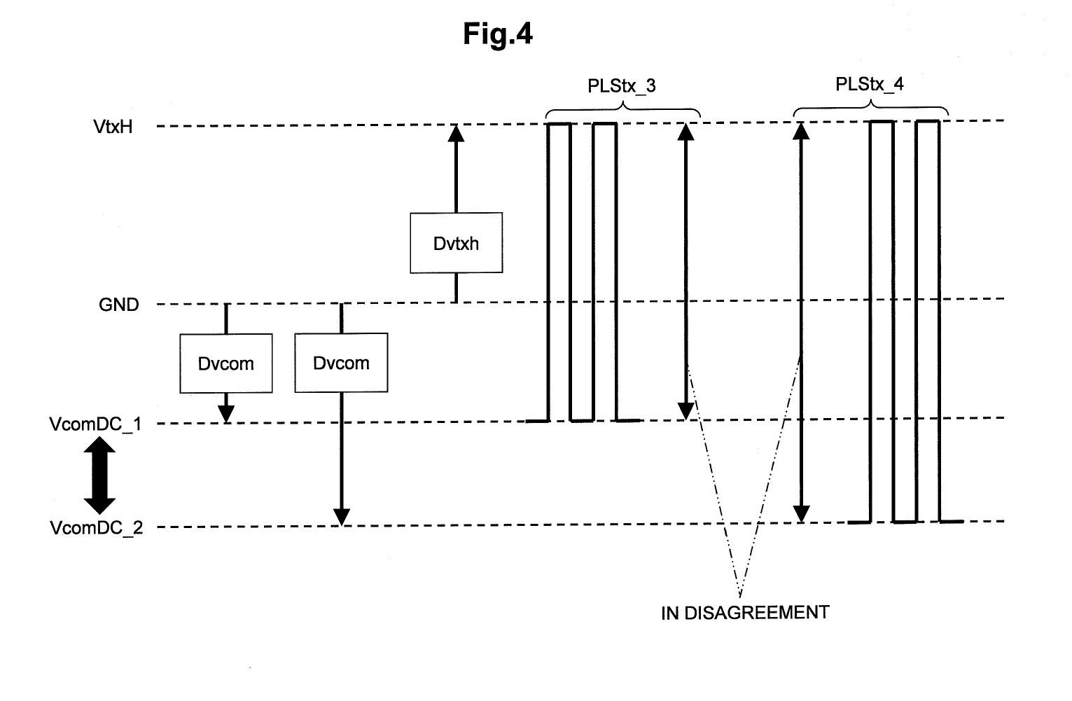

FIG. 4 shows, as a comparative example, voltage generation in the case of designating the high level voltage of a drive pulse instead of amplitude-designating data Dampt. The data designating the high level voltage of the drive pulse is denoted by Dvtxh for the sake of convenience, and designates a voltage with reference to the ground level GND. For instance, in the case of using voltage-designating data Dvcom_1 and high level-designating data Dvtxh, a voltage VcomDC_1 is generated as the common voltage, and a voltage VtxH is generated as the high level voltage of the drive pulse PLStx; the drive pulse PLStx_3 varies with an amplitude having the voltage VcomDC_1 as the low level and the voltage VtxH as the high level. In contrast, in the case of using different voltage-designating data Dvcom_2 as an optimum common voltage, a voltage VcomDC_2 is generated as the common voltage, and a voltage VtxH is generated as the high level voltage of the drive pulse PLStx; the drive pulse PLStx_4 varies with an amplitude having the voltage VcomDC_2 as the low level and the voltage VtxH as the high level. The change in the optimum common voltage will make a difference between drive pulses PLStx_3 and PLStx_4 in amplitude and therefore, the same touch detection accuracy cannot be achieved in the two cases as described above.

Hence, as long as the low-level voltage Vcom and high level voltage VtxH of the drive pulse PLStx are generated by use of voltage-designating data Dvcom and amplitude-designating data Dampt, even with the optimum value of the common voltage Vcom accompanied by variation coming from a liquid crystal display panel per se, such variation is reflected by voltage-designating data Dvcom and in addition, the amplitude of a drive pulse optimum for touch detection is reflected by amplitude-designating data Dampt. Thus, the detection accuracy required for touch detection by use of a drive pulse PLStx arranged with reference to the common voltage Vcom can be ensured even with the common voltage's optimum value accompanied by variation. In this embodiment, the need for adopting, as a DC reference level of the drive pulse, a fixed voltage such as the ground level (see FIG. 4) is eliminated, which brings about the following effects: the number of kinds of output voltages of the TX pulse output circuit 31 serving as the drive circuit is not increased, (for such output voltages, two kinds of voltages Vcom and VtxH will suffice, and the ground level GND is not included therein); the power consumption is not increased; the spare time which can be used for display and touch detection in one display frame period is never shortened; and the circuit scale of the TX pulse output circuit 31 is not increased.

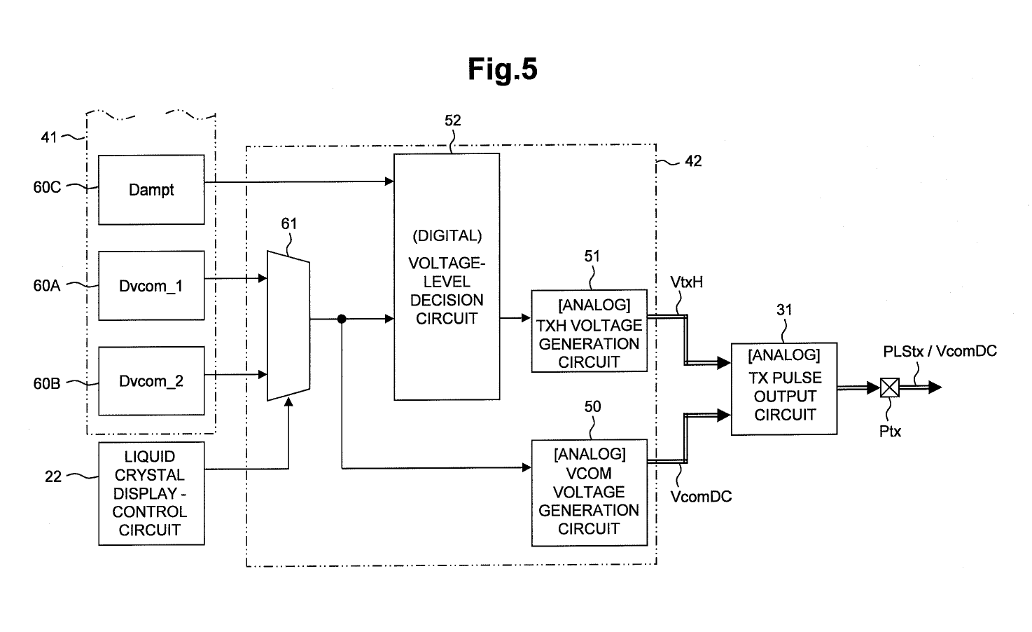

FIG. 5 shows systems for generating the drive pulse PLStx and the common voltage VcomDC in a simplified form in addition to a specific example of the memory region 60. Although no special restriction is intended, the memory region 60 includes: first non-volatile registers 60A and 60B for storing the voltage-designating data Dvcom; and a second non-volatile register 60C for storing the amplitude-designating data Dampt. The optimum value of the common voltage Vcom depending on the liquid crystal display panel 2 and the touch panel 3 can be determined, for example, in the stage of a module test in which the driver IC 4 actually activates the panel module 1. In most cases, once the optimum value is determined, it is not required to change the optimum value. Further, it is expected that the drive pulse amplitude requires appropriately changing keeping a good balance with the detection sensitivity of the touch panel 3 and its low-power consumption mode in terms of the system operation. Taking account of the difference, it is convenient from the viewpoint of use to arrange the memory region 60 for storing the two kinds of data so as to be composed of different non-volatile registers, namely the first non-volatile registers 60A and 60B, and the second non-volatile register 60C. Especially, the second non-volatile register 60C is a register on which data can be electrically written from outside through the host interface 40 and therefore, it can serve for the host processor 5 to overwrite the amplitude-designating data Dampt. For such electrically writable register, a storage element for a flash memory of e.g. a MONOS structure may be adopted. While the first non-volatile registers 60A and 60B which are not designed on the premise that they are subjected to overwrite may be each composed of a trimming circuit with an electric fuse incorporated therein as long as all that is required is just one write thereon, but it is preferred that the first non-volatile registers 60A and 60B are each composed of a non-volatile register which is electrically overwritable like the second register 60C. Making so arrangement on the first non-volatile registers 60A and 60B, the memory region 60 can be assigned to one electrically overwritable non-volatile memory such as a flash memory. In the example of FIG. 3, the first non-volatile registers 60A and 60B are memory regions to separately store the voltage-designating data Dvcom_1 and Dvcom_2 in. The liquid crystal display-control circuit 22 selects, by use of the selector 61 in the voltage-level decision circuit 52, voltage-designating data of one of the first non-volatile registers 60A or 60B according to the display mode. Hence, in a case where even the display mode for driving display lines in an ascending order, a descending order or the like makes a difference in the optimum value of the common voltage Vcom, the optimum common voltage Vcom_1 or Vcom_2 can be adopted according to the display mode, and the switching of the common voltage has no influence on the pulse amplitude of the drive pulse.

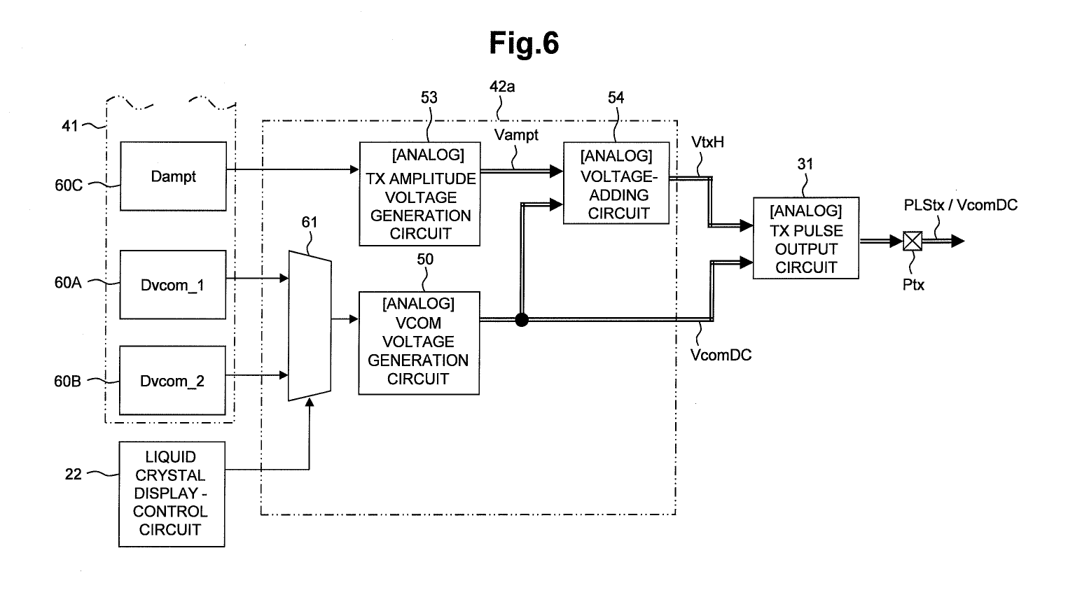

FIG. 6 is a block diagram showing systems for generating the drive pulse PLStx and the common voltage VcomDC in a simplified form in addition to a specific example of the voltage-generation circuit mainly composed of an analog circuit. The voltage-generation circuit 42a shown in FIG. 6, by example, has: a TX amplitude voltage-generation circuit 53 operable to convert amplitude-designating data Dampt into an analog voltage thereby to generate an amplitude voltage Vampt; a VCOM voltage-generation circuit 50 operable to convert voltage-designating data Dvcom_1 or Dvcom_2 into an analog voltage thereby to generate the common voltage Vcom; and a voltage-adding circuit 54 serving as an analog adding circuit operable to add, in analog, the amplitude voltage Vampt generated by the TX amplitude voltage-generation circuit 53 to the common voltage Vcom generated by the VCOM voltage-generation circuit 50, thereby to generate the high level VtxH of the drive pulse PLStx. The structures of other parts or components including non-volatile registers 60A, 60B and 60C are the same as described above. The parts or components having the same functions are identified by the same reference numerals, characters, or combinations thereof, and the detailed descriptions thereof are omitted here.

According to the example shown in FIG. 6, a digital signal is converted into an analog signal, whereby a required voltage addition and the like can be performed actually in an analog process. This is preferable for increasing the number of analog circuit parts mounted on the chip of a driver IC in combination, whereas the structure shown in FIG. 5 is preferable for decreasing the number of analog circuit parts mounted on the chip of a driver IC in combination.

The invention is not limited to the above embodiments. It is obvious that various changes and modifications may be made without departing from the subject matter thereof.

For instance, the display panel is not limited to a liquid crystal panel, and it may be an EL (Electro-Luminescence) panel. The reference level of the voltage-designating data of the common voltage is not limited to a reference of the ground level of the circuit, and it may be any reference as long as it is appropriate. The arrangement for separation of display and touch detection from each other is not limited to the means for dividing one display frame period to include a display-drive period and a non-display-drive period. Another period may be set in one display frame period. The memory region of amplitude-designating data is not limited to a non-volatile register, and it may be formed by a volatile register. The amplitude-designating data and the voltage-designating data may be arranged so that they are loaded from the non-volatile memory into the voltage-generation circuit at power-on reset and then used. The structure of the circuit which generates a drive pulse high level voltage and the like by use of amplitude-designating data, etc. is not limited to the above embodiment. It may be varied appropriately. In addition, the memory region 60 for storing data of the voltage and the amplitude is formed in a non-volatile memory. In addressing these data by address signals and reading out them from the non-volatile memory, the memory circuit 41 will have the function of the selector 61.

In addition, as described with reference to FIG. 2, not only the liquid crystal display driver (LCDDRV) and the touch panel controller (TPC), but also a subprocessor or the like may be mounted on one chip together with the driver IC. Further, the gate driver 6 may be mounted as well.

What is claimed is:

1. A driver IC operable to operate a display panel and a touch panel, comprising:
a memory region for holding voltage-designating data of a common voltage to be applied to a common electrode of pixels of the display panel and amplitude-designating data of a pulse voltage used for driving, by pulses, drive electrodes of the touch panel;
a voltage-generation circuit operable to generate the common voltage based on the voltage-designating data and the amplitude-designating data held by the memory region, and to generate a high level of the pulse voltage with its low level set at the common voltage; and
a drive circuit operable to output a common voltage generated by the voltage-generation circuit in synchronization with an action timing of the display panel, and to output a pulse voltage having an amplitude of the high level with respect to the common voltage generated by the voltage-generation circuit in synchronization with an action timing of the touch panel.

2. The driver IC according to claim 1, further comprising: a liquid crystal display-control circuit operable to control the action timings of the display panel and the touch panel with one frame period of the display panel divided to include a display-drive period and a non-display-drive period,
wherein the liquid crystal display-control circuit causes the drive circuit to output a common voltage in the display-drive period, and the drive circuit to output a pulse voltage in the non-display-drive period.

3. The driver IC according to claim 2, wherein the memory region is formed by: first non-volatile registers for storing the voltage-designating data; and a second non-volatile register for storing the amplitude-designating data.

4. The driver IC according to claim 3, wherein the second non-volatile register includes a register which is electrically writable from outside through a host interface.

5. The driver IC according to claim 4, wherein the first non-volatile registers have memory regions for separately storing more than one piece of the voltage-designating data, and
the liquid crystal display-control circuit selects a required piece of voltage-designating data out of the first non-volatile registers according to a display mode, and provides the voltage-generation circuit therewith.

6. The driver IC according to claim 1, wherein the voltage-generation circuit includes: a digital calculation circuit operable to accept inputs of the amplitude-designating data and the voltage-designating data, and to add a value of the amplitude-designating data to a value of the voltage-designating data;
a high-level generation circuit operable to convert addition data resulting from the addition by the digital calculation circuit into an analog voltage to generate the high level; and
a common voltage-generation circuit operable to convert the voltage-designating data into an analog voltage to generate the common voltage.

7. The driver IC according to claim 1, wherein the voltage-generation circuit has: an amplitude voltage-generation circuit operable to convert the amplitude-designating data into an analog voltage to generate an amplitude voltage;
a common voltage-generation circuit operable to convert the voltage-designating data into an analog voltage to generate the common voltage; and
an analog adding circuit operable to add, in analog, the amplitude voltage generated by the amplitude voltage-generation circuit to the common voltage generated by the common voltage-generation circuit to generate the high level.

8. A driver IC operable to activate a display panel and a touch panel, comprising:
a first drive circuit operable to drive signal electrodes of pixels of the display panel by use of first drive terminals;
a second drive circuit operable to drive a shared electrode doubling as a common electrode of pixels of the display panel and drive electrodes of the touch panel by use of second drive terminals;
a detection circuit operable to detect a voltage change taken from a detection electrode of the touch panel;
a liquid crystal display-control circuit operable to control action timings of the first drive circuit, the second drive circuit, and the detection circuit with one frame period of the display panel divided to include a display-drive period and a non-display-drive period;
a memory region for holding voltage-designating data of a common voltage used for driving the shared electrode, and amplitude-designating data of a pulse voltage used for driving the shared electrode; and
a voltage-generation circuit operable to generate the common voltage and a high level of the pulse voltage with its low level set at the common voltage based on the voltage-designating data and the amplitude-designating data held by the memory region,
wherein the liquid crystal display-control circuit causes the first drive circuit to drive the signal electrodes, and the second drive circuit to drive the second drive terminals by use of the common voltage generated by the voltage-generation circuit in the display-drive period, and
the liquid crystal display-control circuit stops the first drive circuit from driving the signal electrodes, and causes the detection circuit to perform a detecting action, and the second drive circuit to drive the second drive terminals with a pulse voltage having an amplitude of the high level with respect to the common voltage generated by the voltage-generation circuit in the non-display-drive period.

9. A display-input device comprising:
a panel module including a display panel and a touch panel incorporated in the display panel; and
a driver IC operable to activate the display panel and the touch panel and mounted on the panel module,
wherein drive electrodes of the touch panel doubles as a common electrode of pixels of the display panel,
detection electrodes of the touch panel with touch detection capacitances formed at their intersections with the drive electrodes, and scan and signal electrodes of the pixels of the display panel connected with the common electrode are individuated respectively,
the driver IC includes a first drive circuit operable to drive the signal electrodes of the pixels of the display panel,
a second drive circuit operable to drive a shared electrode doubling as the common electrode and the drive electrode,
a detection circuit operable to detect a voltage change taken from the detection electrode of the touch panel,
a memory region for holding voltage-designating data of a common voltage used for driving the shared electrode and amplitude-designating data of a pulse voltage used for driving the shared electrode, and
a voltage-generation circuit operable to generate the common voltage and a high level of the pulse voltage with its low level set at the common voltage based on the voltage-designating data and the amplitude-designating data held by the memory region, and
the second drive circuit drives the shared electrode by use of the common voltage generated by the voltage-generation circuit according to the driving of the signal electrodes by the first drive circuit, and
the second drive circuit drives the shared electrode with a pulse voltage having an amplitude of the high level with respect to the common voltage generated by the voltage-generation circuit, according to the stop of signal electrode driving by the first drive circuit and a detecting action by the detection circuit.
